(19) United States
(12) Patent Application Publication
(10) Pub. No.: US 2025/0352952 A1
(43) Pub. Date: Nov. 20, 2025

(54) Integrated electrochemical cell and method for lithium extraction from brine and conversion to lithium product

(71) Applicant: Electroflow Technologies, Inc., Burlingame, CA (US)

(72) Inventors: Eric McShane, Foster City, CA (US); Evan Gardner, San Francisco, CA (US); Daniel Collins-Wildman, Oakland, CA (US)

(21) Appl. No.: 19/208,365

(22) Filed: May 14, 2025

Related U.S. Application Data
(60) Provisional application No. 63/648,002, filed on May 15, 2024.
(60) Provisional application No. 63/743,186, filed on Jan. 8, 2025.

(51) Int. Cl. B01D 61/46

(52) U.S. Cl. CPC B01D 61/463; B01D 61/46; B01D 2313/32; B01D 2313/345

(57) ABSTRACT

An integrated electrochemical cell and method for processing lithium brine to obtain recovered lithium and produce a lithium product in a single continuous process. The integrated cell has a catholyte chamber with an intercalating electrode for lithium recovery from a lithium brine streaming through the catholyte chamber. A first anion exchange membrane separates the catholyte chamber from a buffer chamber. The buffer chamber streams a salt of a brine-predominant anion (e.g., a chloride salt for lithium brine containing predominantly chloride salt, or a carbonate salt for lithium brine containing predominantly carbonate salt) for removing the brine-predominant anion and thus preventing precipitation of salt species on first anion exchange membrane. An intermediate membrane separates the buffer chamber from a compatible anion chamber that streams a compatible salt that contains compatible or product anions desired for formation of the lithium product. A second anion exchange membrane separates compatible anion chamber from an anolyte chamber. The anolyte chamber has a lithium de-intercalating electrode for releasing lithium ions and it streams a lithium-bearing solution to obtain the lithium product through pairing of lithium ions with the product anions received from the compatible anion chamber via the second anion exchange membrane. A voltage source is provided for applying a potential difference between the electrodes to drive the process.

### CROSS-REFERENCE TO RELATED APPLICATIONS

This application claims priority from U.S. Provisional Patent Application No. 63/648,002 filed on May 15, 2024 and from U.S. Provisional Application No. 63/743,186 filed on Jan. 8, 2025 both of which are incorporated herein by reference for all purposes in their entirety.

### FIELD OF THE INVENTION

The present invention relates generally to lithium chemical production in a manner that combines the extraction of lithium from brine with its conversion to useful lithium products and belongs to the field of electrochemical processing.

### BACKGROUND OF THE INVENTION

The world is witnessing accelerating adoption of electric vehicles (EVs) and continued growth in various types of devices powered by batteries. Most of the batteries used by EVs and electronic devices rely on lithium. Lithium is the 25th most abundant metal on the planet and well over 90% of battery storage capacity is accounted for by Li-ion batteries. The current and projected growth in their adoption has put tremendous pressure on virtually all steps involved in the production of lithium-ion batteries, including the lithium chemical supply chain. In particular, the lithium chemical supply chain must scale rapidly to meet the projected demand, especially for EVs, battery grid storage, drones and robots. The predominant forms of lithium used for battery cathode synthesis are lithium carbonate (Li₂CO₃) and lithium hydroxide (LiOH). Li₂CO₃ is commonly used to produce lithium iron phosphate (LiFePO₄, or LFP), a cost effective but lower energy density cathode material. LiOH is most commonly used to produce nickel manganese cobalt oxide (NMC), a more costly and higher energy density cathode material.

The lithium supply chain relies on lithium resources mainly present in solid ore (e.g., spodumene and lepidolite) and in saltwater brine. Lithium can be extracted from hard rock containing the solid ore. The hard rock approach generally begins with crushing and heating in order to increase the surface area and the mobility of constituent ions. Then, lithium is typically leached from the rock via sulfuric acid roasting, producing aqueous Li₂SO₄. From Li₂SO₄ one can produce either Li₂CO₃ or LiOH.

To produce Li₂CO₃, Na₂CO₃ is added at elevated temperature (typically 90° C. due to retrograde solubility of Li₂CO₃) and Li₂CO₃ is precipitated, leaving behind a Na₂SO₄ waste stream. As Na₂SO₄ has few industrial applications, it is traditionally requisitioned as waste, and some Na₂SO₄ or Na₂CO₃ species can contaminate the Li₂CO₃ product. To produce LiOH, NaOH is added to the Li₂SO₄ solution to yield LiOH and Na₂SO₄. The Na₂SO₄ is then precipitated and requisitioned as waste, leaving relatively pure aqueous LiOH. Still, the aqueous LiOH is often contaminated with sodium species due to the high solubility of Na₂SO₄ and NaOH. Energy intensive evaporation methods are then required to produce solid LiOH product. In all, the extraction of lithium from hard rock and conversion to the appropriate lithium chemical form require large quantities of caustic and hazardous sulfuric acid, high amounts of energy and multiple unit operations, all of which add significant operating costs.

Notably, over 70% of exploitable lithium resources in the world exist in the form of brine. According to the 2020 US Geological Survey (USGS) most of the world's continental brine (about 80,000 tons) are found in Bolivia, Argentina, Chile, Australia and China. Brine is defined as a high saline solution with average total dissolved solids (TDS) concentrations ranging between 35-330 g/L. The most common cations found in brines are lithium (Li⁺), sodium (Na⁺), magnesium (Mg⁺²) and calcium (Ca⁺²). The most abundant anions in brines are chloride (Cl⁻), carbonate (CO₃⁻²) and sulfate (SO₄⁻²). It is noteworthy that the brines found in South America have a low mass ratio of magnesium (Mg) to lithium (Li), which is advantageous as Mg⁺² cations in brine interfere with traditional methods of lithium extraction from evaporation ponds.

In the brine extraction process, lithium is typically extracted initially as aqueous LiCl. To convert to Li₂CO₃, Na₂CO₃ is then added at elevated temperature, resulting in aqueous NaCl waste and a precipitated Li₂CO₃ product. To convert this Li₂CO₃ solid to LiOH, yet another step is required. Specifically, aqueous Ca(OH)₂ is added to Li₂CO₃, resulting in precipitation of CaCO₃ and leaving a pure aqueous LiOH phase. The drawbacks of this approach are the use of multiple chemical reagents (both Na₂CO₃ and Ca(OH)₂), the potential entrapment of lithium in the CaCO₃ precipitate and high energy requirements.

An alternative emerging approach to LiOH conversion is via water electrolysis. In this method, water reduction produces hydroxide ions on the cathode, and either water oxidation or chloride oxidation occurs on the anode, producing either oxygen or chlorine gas, respectively.

Lithium cations are then selectively combined with hydroxide counter-ions using ion-selective membranes, producing a pure LiOH product. The main drawback of this approach is the extremely high electrical energy requirement, as water electrolysis is notoriously energy-intensive due to the large (>1.2 V) cell voltage required to split water. Electrolysis approaches also suffer from poor efficiencies for LiOH production due to crossover of protons across the membrane, neutralizing produced hydroxide ions.

Thorough summaries of prior art approaches to processing lithium from aqueous sources can be found in many publications including Zavahir, et al. “A review on lithium recovery using electrochemical capturing systems”, Desalination Vol. 500, Elsevier, 2020, pgs. 1-31; Xiong, et al., “REVIEW: Electrochemical lithium extraction from aqueous sources”, Matter Vol. 5, Elsevier, 2022, pgs. 1760-1791; Liu, et al. “Lithium Extraction from Seawater through Pulsed Electrochemical Intercalation”, Joule Vol. 4, Elsevier, 2020, pgs. 1459-1469; Xu, et al. “A Comprehensive Membrane Process for Preparing Lithium Carbonate from High Mg/Li Brine”, Membranes, Vol. 10, 2020, pgs. 1-14.

Some prior art references contain teachings that extend to combinations of steps involved in extraction and/or enrichment of lithium. For example, U.S. Pat. No. 9,062,385 to Zhao et al. teaches a method and device for extracting and enriching lithium as LiCl without conversion to Li₂CO₃ or LiOH. Further, U.S. Pat. No. 10,648,090 to Snydacker et al. teaches an integrated system for lithium extraction and conversion in separate steps. U.S. Pat. No. 10,759,671 to Park et al. teaches a method for manufacturing lithium hydroxide and lithium carbonate using a device that does not integrate extraction. Still further teachings on various combinations of steps without full integration are found in references such as US Published Application 20210323833 to Dai et al.; US Published Application 20220380917 to Dara et al.; US Published Application 20230159345 to Wedlin et al. as well as U.S. Pat. No. 11,578,414 to Riabtsev et al. Additionally, teachings that combine the steps of extraction from brine and production of lithium salt products are found in US Published Application 20200283921 to Mislan.

Despite the numerous prior art teachings, none of the references address a fully integrated approach that saves on reagents, stays at a relatively low temperature (e.g., below 60° C.), avoids energy intensive water electrolysis or complicated systems in which electrodes are physically rolled through chambers of various solutions. In addition, none of the prior art teachings address both extraction from brine and conversion to a lithium product in a single electrochemical cell.

### OBJECTS AND ADVANTAGES

It is an object of the invention to provide an integrated electrochemical cell, a system using such cell and method that deploys a single integrated electrochemical cell for both the extraction of lithium from brine as well as conversion to a lithium product.

It is a further object of the invention to provide for an integrated electrochemical cell, system and method that does not require elevated temperatures above 60° C. or moving parts, such as electrodes which roll through chambers of various solutions. The advantages of the integration according to the invention include reduced energy requirements, lower CO₂ footprint and reduced cost in obtaining Lithium product such as Li₂CO₃ and LiOH.

### SUMMARY OF THE INVENTION

The objects and advantages of the invention are provided for by an integrated electrochemical cell for processing Lithium brine to obtain a recovered Lithium and for producing a Lithium product, as well as the Lithium product obtained in this manner. The integrated chemical cell has a catholyte chamber for admitting the Lithium brine. The catholyte chamber has a Lithium intercalating electrode for intercalating the recovered Lithium from the Lithium brine. The catholyte chamber also has a first anion exchange membrane. A buffer chamber is sandwiched between the first anion exchange membrane of the catholyte chamber and an intermediate membrane, which may or may not be ion selective depending on the embodiment. The buffer chamber is designed for streaming a salt of a brine-predominant anion to remove that brine-predominant anion from the catholyte chamber through the first anion exchange membrane. Depending on the embodiment, the brine-predominant anions will typically be chloride anions, carbonate anions or sulfate anions. Correspondingly, the salt of the brine-predominant anion is a chloride salt, a carbonate salt or a sulfate salt. The buffer chamber thus prevents precipitate formation on the first anion exchange membrane, which is especially important in the case of the brine-predominant anion being chloride. If the buffer chamber were removed, species from Lithium brine in the catholyte chamber (e.g., calcium and magnesium cations) could come into direct contact with anions (e.g., hydroxide or carbonate cations) from an adjacent chamber that could cause precipitation of salt species (e.g., calcium carbonate) on the first anion exchange membrane.

Further, the integrated electrochemical cell has a compatible anion chamber sandwiched between the intermediate membrane, which is an ion selective membrane in some embodiments, and a second anion exchange membrane. The compatible anion chamber streams a compatible compound, e.g., a compatible salt, which is compatible for obtaining product anions for the Lithium product. The product anions from the compatible anion chamber are passed through the second anion exchange membrane to an anolyte chamber positioned adjacent to the second anion exchange membrane. For clarity of explanation such compatible compound or salt may sometimes be referred to herein as Lithium product compatible salt or Lithium product compatible compound. The anolyte chamber has a Lithium de-intercalating electrode for releasing Lithium into the anolyte chamber. Furthermore, the anolyte chamber streams a Lithium-bearing solution. Production of the Lithium product occurs in the anolyte chamber through pairing with the product anions received through the second anion exchange membrane from the compatible anion chamber.

The integrated electrochemical cell is further equipped with a voltage source for applying a potential difference between the Lithium intercalating electrode and the Lithium de-intercalating electrode. The application of the potential difference or voltage potential drives the intercalating of the recovered Lithium in the catholyte chamber and production of Lithium product in the anolyte chamber. The membranes support the passage of corresponding ions through the integrated electrochemical cell to allow for these processes to proceed.

The integrated electrochemical cell supports production of various Lithium products and more specifically of different Lithium salt recovery solutions. In one embodiment, the Lithium salt recovery solution is aqueous LiOH and the compatible compound for obtaining the Lithium product is a compatible salt, specifically hydroxide salt. In another embodiment, the Lithium salt recovery solution is aqueous Li₂CO₃ and the compatible salt for Lithium product formation is a carbonate salt. In still another embodiment, the Lithium salt recovery solution is aqueous LiHCO₃ and the compatible salt for Lithium product formation is a carbonate salt or a bicarbonate salt. In yet another embodiment, the Lithium salt recovery solution is aqueous Li₃PO₄ and the compatible salt for Lithium product formation is a phosphate salt. In any of these embodiments, the integrated electrochemical cell can further be provided with a processing unit connected to the anolyte chamber. The processing unit admits the Lithium salt recovery solution and processes it to obtain a solid Lithium product.

It is preferable that the voltage source of the integrated electrochemical cell be a reversible voltage source. Such reversible voltage source can apply a reversed potential difference between the Lithium intercalating electrode and the Lithium de-intercalating electrode to reverse the polarity of the integrated electrochemical cell. This reversal is preferably applied when the Lithium intercalating electrode approaches a certain level of lithiation, e.g., near full lithiation, or when the Lithium de-intercalating electrode approaches a certain level of de-lithiation, e.g., near full de-lithiation. The reversal of polarity applied at this point, also referred to as “electroswing process”, permits the electrochemical cell to continue operating but with reversed polarity. In other words, the electrodes switch their function and the electrode previously functioning as the anode now functions as the cathode and vice versa. When this occurs, the streams are also flipped about the center of the cell (i.e., the anolyte is swapped with the catholyte, and the buffer chamber stream is swapped with the compatible anion chamber stream).

The integrated electrochemical cell permits the use of various types of electrode materials. For example, the Lithium intercalating and the Lithium de-intercalating electrodes are made of electrode materials selected from among LiFePO₄, LiₓMe_{y}FePO₄, LiFeₓMe_{y}PO₄, LiFePO₄/C, LiₓMe_{y} FePO₄/C, LiFeₓMe_{y}PO₄/C, or a mixture thereof, in which, Me represents Mn, Co, Mo, Ti, Al, Ni, Nb, or a mixture thereof and the values of x and y are 0<x<1 and 0<y<1. Furthermore, the electrodes admit of various advantageous geometries and configurations that increase their effective areas and volumes. For example, the electrodes can be in the form of a foam coated with the electrode material.

The present invention, including the preferred embodiment, will now be described in detail in the below description with reference to the attached drawing figures.

### BRIEF DESCRIPTION OF THE DRAWING FIGURES

FIG. 1A is a schematic diagram of an integrated electrochemical cell according to the invention

FIG. 1B is a cross-sectional diagram of the integrated electrochemical cell of FIG. 1A

FIG. 1C is a plot of voltage potential V as a function of time across the integrated electrochemical cell of FIG. 1A

FIG. 2A is a schematic diagram of another integrated electrochemical cell according to the invention

FIG. 2B are plots showing the voltage over time in the integrated electrochemical cell of FIG. 2A

FIG. 3 is a schematic diagram of a chemical system deploying an integrated electrochemical cell for obtaining LiOH as Lithium product and using Ca(OH)₂ as compatible salt for Lithium product formation

FIG. 4 is a schematic diagram of a chemical system deploying an integrated electrochemical cell for obtaining LiOH as Lithium product and using NaOH as compatible salt for Lithium product formation

FIG. 5 is a schematic diagram of a chemical system deploying an integrated electrochemical cell containing a cation exchange membrane in the center for obtaining LiOH as Lithium product and using NaOH as compatible salt for Lithium product formation

FIG. 6 is a schematic diagram of a chemical system deploying an integrated electrochemical cell containing a cation exchange membrane in the center for obtaining Li₂CO₃ as Lithium product and using (NH₄)₂CO₃ as compatible salt for Lithium product formation

FIG. 7 is a schematic diagram of a chemical system deploying an integrated electrochemical cell in a modified process for obtaining electrode materials such as LiFePO₄ (LFP) via in-line hydrothermal (HT) synthesis

FIG. 8 is a schematic diagram of an integrated electrochemical cell stack including a number of integrated electrochemical cells according to the invention

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

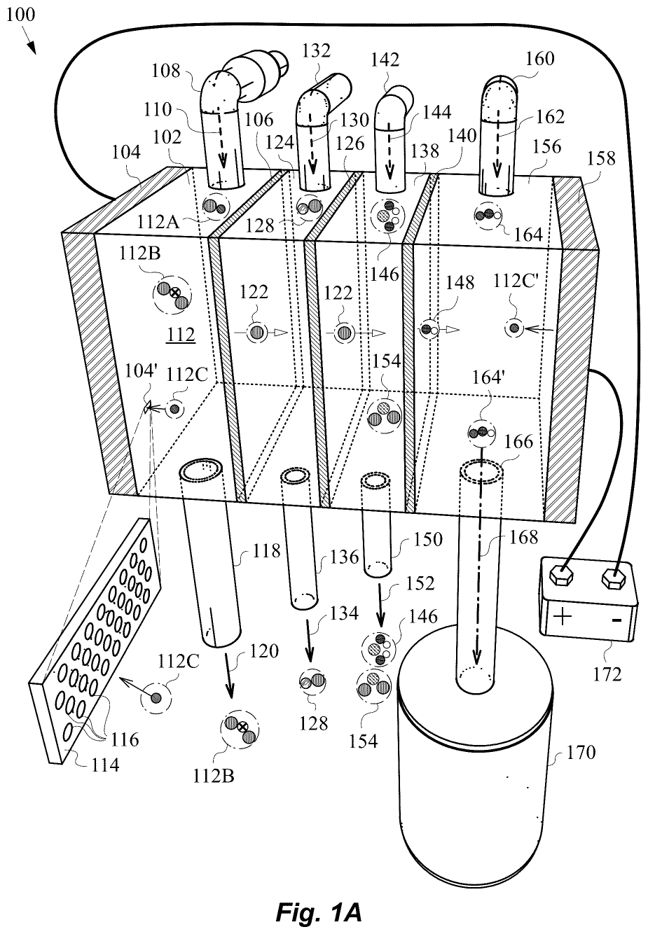

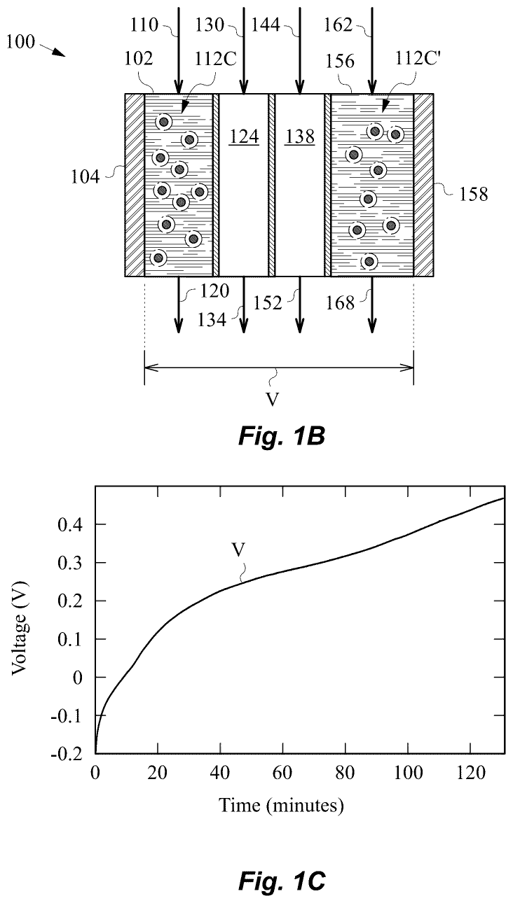

FIG. 1A is a three-dimensional schematic diagram of an integrated electrochemical cell 100 according to the invention. Integrated electrochemical cell 100 has a catholyte chamber 102 with a Lithium intercalating electrode 104 on one side and a first ion exchange membrane 106 on the other side. A brine supply pipe 108 is provided to deliver a flow 110 of a Lithium brine 112 into catholyte chamber 102.

The component of interest in Lithium brine 112 is Lithium Chloride (LiCl) 112A shown in a highly magnified form within a dashed and dotted outline. Of course, Lithium brine 112 also includes various other components, such as Magnesium Chloride (MgCl₂) 112B, which is illustrated in a highly magnified form within a dashed and dotted outline. Still other components such as carbonates and chlorides that usually include Potassium (K), Calcium (Ca) and Bromine (Br) are typically present in Lithium brine 112. These additional components are not expressly shown in FIG. 1A for reasons of clarity.

Lithium intercalating electrode 104 is made of an electrode material 114. A small portion 104′ of electrode 104 is shown in an enlarged view to better visualize the structure of intercalating electrode material 114. As shown in this enlarged view, electrode material 114 is of a type that has a number of sites 116 designed to capture or intercalate positively charged Li⁺ ions or Li⁺ cations 112C. For clarity of explanation, Li⁺ cations 112C are illustrated in FIG. 1A in a highly magnified form within dashed and dotted outlines. Suitable electrode material 114 that performs intercalation can be selected from among a wide variety of materials. These include LiFePO₄, LiₓMe_{y}FePO₄, LiFeₓMe_{y}PO₄, LiFePO₄/C, LiₓMe_{y} FePO₄/C, LiFeₓMe_{y}PO₄/C, or a mixture thereof, in which, Me represents Mn, Co, Mo, Ti, Al, Ni, Nb, or a mixture thereof and the values of x and y are 0<x<1 and 0<y<1.

Catholyte chamber 102 is further equipped with a depleted brine outlet pipe 118. Outlet pipe 118 is provided for removing a depleted brine 120 from catholyte chamber 102. Specifically, depleted brine 120 arises from Lithium brine 112 when the latter has become largely devoid of Li⁺ cations 112C. Outlet pipe 118 typically leads to ground or storage to remove depleted brine 120 from any further reactions.

First anion exchange membrane 106 passes negatively charged ions or anions. FIG. 1A illustrates a particular Cl⁻ anion 122 in a highly magnified form within a dashed and dotted outline passing through first anion exchange membrane 106 and out of catholyte chamber 102. Suitable materials for first anion exchange membrane 106 include quaternary ammonium-based materials.

Integrated electrochemical cell 100 has buffer chamber 124 sandwiched between first anion exchange membrane 106 of catholyte chamber 102 and an intermediate membrane 126. Buffer chamber 124 is designed for streaming a salt 128 of a brine-predominant anion, which in the present embodiment is Cl⁻ anion 122. Given that brine-predominant anion in this example is Cl⁻ anion 122 salt 128 is chloride salt.

Chloride salt 128 is delivered in an aqueous flow 130 through a chloride salt supply pipe 132 and removed in aqueous form of a flow 134 through a chloride salt outlet pipe 136. Chloride salt 128 is provided for removing Cl⁻ anions 122 arriving from catholyte chamber 102 through first anion exchange membrane 106. In the present embodiment chloride salt 128 is Sodium Chloride (NaCl) of which a particular molecule 128A is shown in a highly magnified view within a dashed and dotted outline. Note that in the present embodiment intermediate membrane 126 also allows for passage of Cl⁻ anions 122. In other words, intermediate membrane 126 is ion selective. In some embodiments, intermediate membrane 126 may be cation selective, or it may be a membrane that is not ion selective and permits traversal by entire salt species.

Further, integrated electrochemical cell 100 has a compatible anion chamber 138 sandwiched between intermediate membrane 126 and a second anion exchange membrane 140. Compatible anion chamber 138 has a compatible compound or compatible salt supply pipe 142 for streaming a flow 144 of a compatible compound 146 which is a compatible salt in this embodiment. Compatible salt 146 for Lithium product formation is indicated in a highly enlarged view within a dashed and dotted outline. In the present embodiment, compatible salt 146 for Lithium product formation is a hydroxide salt, more specifically still it is Calcium Hydroxide (Ca(OH)₂). Compatible salt 146 is compatible for Lithium product formation because it yields product anions, which in the present case are hydroxide anions (OH⁻) as indicated with an exemplary OH⁻ anion 148 in magnified form within dashed and dotted outline.

An anion exchange chamber outlet pipe 150 is provided for transporting a flow 152 of unused compatible salt 146 as well as of a chloride salt 154 that results from pairing between anions 122 arriving from ion buffer chamber 136 and cations from compatible salt 146 supporting Lithium product formation. In the present example, the cations from Lithium product compatible salt 146 are Calcium cations (Ca⁺²) and hence chloride salt 154 is CaCl₂, as indicated in the magnified and enlarged view within dashed and dotted lines. It should be noted that chloride salt 154 is actually in a hydrated state and its more accurate and complete visualization would detract from the present description.

An anolyte chamber 156 is located adjacent to second anion exchange membrane 140 and thus next to compatible anion chamber 138. Anolyte chamber 156 has a Lithium de-intercalating electrode 158 opposite from second anion exchange membrane 140. A Lithium-bearing solution supply pipe 160 is provided to deliver a flow 162 of a Lithium-bearing solution 164 into anolyte chamber 156. In the present embodiment Lithium-bearing solution 164 is LiOH as indicated in the highly magnified view within dashed and dotted outline. Lithium-bearing solution 164 can be fresh or recycled.

Lithium de-intercalating electrode 158 is also made of electrode material 114. Under application of positive potential Lithium de-intercalating electrode 158 releases or de-intercalates positively charged Li⁺ ions or Li⁺ cations 112C′. For clarity of explanation, Li⁺ cations 112C′ being de-intercalated are designated with a prime to distinguish them from Li⁺ cations 112C being intercalated by Lithium intercalating electrode 104 of catholyte chamber 102. As stated above, suitable electrode material 114 that performs de-intercalation can be selected from among a wide variety of materials such as LiFePO₄, LiₓMe_{y}FePO₄, LiFeₓMe_{y}PO₄, LiFePO₄/C, LiₓMe_{y}FePO₄/C, LiFeₓMe_{y}PO₄/C, or a mixture thereof, in which, Me represents Mn, Co, Mo, Ti, Al, Ni, Nb, or a mixture thereof and the values of x and y are 0<x<1 and 0<y<1.

Anolyte chamber 156 is set up to receive product anions 148 from anion exchange chamber 138 through second anion exchange membrane 140. This produces the requisite operating conditions for producing a Lithium product 164′, which in the present case is aqueous LiOH as shown in the enlarged view within dashed and dotted outline. Now, Lithium product 164′ is in fact a Lithium salt recovery solution. Thus, because Lithium product 164′ is chemically analogous to Lithium-bearing solution 164 it is designated with a prime in order to distinguish it. An anolyte chamber outlet pipe 166 is provided for removing a flow 168 of Lithium product 164′ to a tank 170.

Integrated electrochemical cell 100 is further equipped with a voltage source 172 for applying a voltage potential or potential difference between Lithium intercalating electrode 104 of catholyte chamber 102 and Lithium de-intercalating electrode 158 of anolyte chamber 156. The application of suitable voltage potential drives the intercalation of recovered Lithium 112C in catholyte chamber 102 and contemporaneous production of Lithium product 164′ in anolyte chamber 156. Voltage source 172 is a reversible voltage source, meaning that its polarity can be reversed. The reasons for such polarity reversal are explained below.

During operation, flow 110 of Lithium brine 112 is supplied through brine supply pipe 108 into catholyte chamber 102. At the same time, a negative overpotential is applied to Lithium intercalating electrode 104 using voltage source 172, thereby reducing electrode material 114 of Lithium intercalating electrode 104. As a result, Li⁺ cations 112C get captured or intercalated in sites 116 of electrode material 114. This process depletes Lithium brine 112 of Lithium by removing Li⁺ cations 112C. Thus, as it passes through catholyte chamber 102 Lithium brine 112 converts to depleted brine 120 mostly devoid of Li⁺ cations 112C. Outlet pipe 118 passes depleted brine 120 to ground or storage.

Simultaneously with the passing of Lithium brine 112 through catholyte chamber 102, flow 162 of Lithium-bearing solution 164 is passed through anolyte chamber 156 from Lithium-bearing solution supply pipe 160. Because of the positive overpotential applied to Lithium de-intercalating electrode 158 by voltage source 172, electrode material 114 of Lithium de-intercalating electrode 158 is oxidized and Li⁺ cations 112C′ are de-intercalated and enter Lithium-bearing solution 164 where they form Lithium product 164′. Advantageously, any remainder of Lithium product 164′ is recycled into anolyte chamber 156 as Lithium-bearing solution 164.

In the present embodiment, Lithium-bearing solution 164 is LiOH. Thus, de-intercalated Li⁺ cations 112C′ enter LiOH solution 164 as it is streaming through anolyte chamber 156. Additionally, product anions 148 passing from compatible anion chamber 138 through second anion exchange membrane 140 also enter LiOH solution 164. In the present embodiment, product anions 148 are hydroxide anions OH⁻. Under these conditions in anolyte chamber 156 production of Lithium product 164′ occurs through pairing of de-intercalated Li⁺ cations 112C′ with hydroxide anions 148. Thus, in the present embodiment Lithium product 164′ is LiOH, which is a pure Lithium salt recovery product in solution. It is removed from anolyte chamber 156 in the form of flow 168 through anolyte chamber outlet pipe 166.

Lithium product 164′ in the form of salt recovery solution delivered to tank 170 can be crystallized from solution downstream in various ways. For example, standard crystallization or mechanical vapor recompression can be deployed to yield crystallized Lithium product 164′.

During operation, ion buffer chamber 124 functions to facilitate transport of Cl⁻ anions 122 out of catholyte chamber 102 and to avoid precipitation on first ion exchange membrane 106. Specifically, direct contact between catholyte chamber 102 and compatible anion chamber 138 could result in Magnesium Chloride (MgCl₂) 112B and salts of other components present in Lithium brine 112 contacting hydroxide or carbonate cations in anion-exchange solution, resulting in precipitation of species such as Magnesium Hydroxide (Mg(OH)₂) on first anion exchange membrane 106. These precipitated salts could also include Magnesium Carbonate, Calcium Carbonate and Calcium Hydroxide in the absence of buffer chamber 124. Specifically, as the precipitates are likely to precipitate on anion exchange membranes, the presence of buffer chamber 124 that streams chloride salt 128 to avoid this is important. Note that chloride salt 128 exiting as flow 134 through chloride salt outlet pipe 136 can be recycled back into buffer chamber 124 through chloride salt supply pipe 132. If necessary, adjustments to the concentration of chloride salt 128 prior to recycling can be made as well.

The action of chloride salt 128 in buffer chamber 124 thus permits Cl⁻ anions 122 to be transported without the risk of undesired precipitation of salts through intermediate membrane 126 into compatible anion chamber 138. The streaming of flow 144 containing compatible salt 146 for Lithium product formation, in this case Ca(OH)₂, creates the conditions for ion exchange inside compatible anion chamber 138. More precisely, the ion exchange is an anion exchange of Cl⁻ anions 122 for OH⁻ anions that are product anions 148 in the present embodiment. The exchange occurs because Cl⁻ anions 122 form chloride salt 154, CaCl₂ in the present example, while product anions or OH⁻ anions 148 are liberated from compatible salt 146. The freed OH⁻ anions 148 pass through second anion exchange membrane 140 into anolyte chamber 156 due to the potential difference applied between intercalating and de-intercalating electrodes 104, 158 by voltage source 172.

As compatible salt 146 gains Cl⁻ cations 122 and loses the desired product anions 148 its supply needs to be replenished. This replenishment arrives through compatible salt supply pipe 142. Meanwhile, flow 152 laden with chloride salt 154 is removed through anion exchange chamber outlet pipe 150. To the extent that some compatible salt 146 remains in flow 152 it can be recycled. Crystallization methods or membrane separation processes known in the art can be deployed to recycle compatible salt 146 and reintroduce it into buffer chamber 124 via compatible salt supply pipe 142. Any deficit in compatible salt 146 is made up from fresh supply.

The process operates until intercalating electrode 104 and/or de-intercalating electrode 158 reach certain lithiation states. Specifically, after a certain amount of time intercalating electrode 104 will approach a certain level of lithiation as Li⁺ cations 112C are trapped in sites 116 offered by electrode material 114. At full lithiation intercalating electrode 104 will thus stop being able to continue its capture of Li⁺ cations 112C. Similarly, after a certain amount of time de-intercalating electrode 158 will be depleted of Li⁺ cations 112C′. It will thus stop being able to provide further Li⁺ cations 112C′ necessary for production of Lithium product 164′.

FIG. 1B is a cross-sectional diagram of integrated electrochemical cell 100 that illustrates the concentration of Li⁺ cations 112C in catholyte chamber 102 and the concentration of Li⁺ cations 112C′ in anolyte chamber 156. These concentrations will vary with time, as explained above. Specifically, FIG. 1B shows these concentrations at the beginning of operation when voltage source 172 (see FIG. 1A) is first connected to integrated electrochemical cell 100 to drive the intercalation at electrode 104 and de-intercalation at electrode 158.

As time passes, voltage potential V applied across electrochemical cell 100 and indicated in FIG. 1B changes until further lithiation of intercalating electrode 104 with Li⁺ cations 112C and/or further supply of Li⁺ cations 112C′ required for making Lithium product 164′ (see FIG. 1A) are no longer supported. The change in concentrations of Li⁺ cations 112C in catholyte chamber 102 and of Li⁺ cations 112C′ in anolyte chamber 156 from the start of operation (before) until the end (after) is indicated in TABLE 1, below.

TABLE 1

| | Catholyte | Anolyte |
|---|---|---|
| | (in catholyte | (in anolyte |
| | chamber 102) | chamber 156) |
| Li⁺ concentration at the | 157 | 104 |
| start (ppm) - before | | |
| Li⁺ concentration at the | 3 | 174 |
| end (ppm) - after | | |

FIG. 1C is a plot that illustrates the accompanying change in voltage potential V over time across integrated electrochemical cell 100. Note that the voltage potential V is measured between intercalating and de-intercalating electrodes 104 and 158. If left running for long enough, intercalating electrode 104 may approach full lithiation and/or de-intercalating electrode 158 may approach full de-lithiation. At this point, integrated electrochemical cell 100 will no longer operate in the desired manner.

In order to address this challenge and to ensure continuous operation, voltage source 172 is reversible, as mentioned above. Reversible voltage source 172 reverses the potential difference between Lithium intercalating electrode 104 and Lithium de-intercalating electrode 158 when electrochemical cell 100 no longer operates due to lithiation and/or de-lithiation levels. In other words, voltage is reversed when Lithium intercalating electrode 104 approaches a certain level of lithiation, e.g., near or full lithiation, or when the Lithium de-intercalating electrode 158 approaches a certain level of de-lithiation, e.g., near or full de-lithiation.

The reversal of the polarity of integrated electrochemical cell 100 permits it to operate, but in the reverse order. Due to the reversal electrodes 104, 158 switch their function. Lithium intercalating electrode 104 previously functioning as the anode now functions as the cathode. Lithium de-intercalating electrode 158 previously functioning as the cathode now functions as the anode. This reversal of polarity is also referred to as an “electroswing process”. It permits electrochemical cell 100 to continue operating but with reversed polarity.

Of course, due to the reverse order of operation in the electroswing process, the operation of chambers 102, 124, 138 and 156 has to be reversed as well. Thus, flow 110 of a Lithium brine 112 is now passed through pipe 160 into previous anolyte chamber 156 which now functions as the catholyte chamber. Similarly, flow 162 of Lithium-bearing solution 164 is supplied through pipe 108 into previous catholyte chamber 102 which now functions as the anolyte chamber. Likewise, flows 130 and 144 are swapped between pipes 132 and 142 to interchange the functions of buffer chamber 124 and compatible anion chamber 138.

Integrated electrochemical cell 100 has the advantage of operating at ambient temperatures and not requiring electrolysis (water splitting), which is energy intensive. Furthermore, integrated electrochemical cell 100 does not require any moving parts such as electrodes which are rolled through chambers of solution.

Integrated electrochemical cell 100 supports production of various Lithium products and more specifically of different Lithium salt recovery solutions. In the embodiment described above Lithium product 164′ is Lithium salt recovery solution of aqueous LiOH. Hence, the compatible compound in this embodiment is compatible salt 146 in the form of a hydroxide salt, specifically Ca(OH)₂. In another embodiment Lithium product can be Lithium salt recovery solution of aqueous Li₂CO₃. In this embodiment compatible salt 146 is a carbonate salt. In another embodiment Lithium product can be Lithium salt recovery solution of aqueous LiHCO₃. In this embodiment compatible salt 146 is a carbonate salt or a bicarbonate salt. In still another embodiment the Lithium salt recovery solution is aqueous Li₃PO₄ and compatible salt 146 is a phosphate salt. In any of these embodiments the integrated electrochemical cell can further be provided with a processing unit connected to the anolyte chamber. The processing unit admits the Lithium salt recovery solution and processes it to obtain a solid Lithium product.

Integrated electrochemical cell 100 also supports operation with different types of Lithium brine 112 delivered in flow 110. Specifically, integrated electrochemical cell 100 is adjusted based on what brine-predominant anions need to be removed from catholyte chamber 102 (i.e., brine-predominant anion may not be Cl⁻ anion 122). For example, in some embodiments brine-predominant anions 122 will be carbonate anions (CO₃⁻²) or sulfate anions (SO₄⁻²). Correspondingly, salt 128 of the brine-predominant anion is then chosen to be a carbonate salt or a sulfate salt, respectively.

Furthermore, Lithium intercalating electrode 104 and Lithium de-intercalating electrode 158 admit of various advantageous geometries and configurations that increase their effective areas and volumes. For example, electrodes 104, 158 can be in the form of a foam coated with the electrode material.

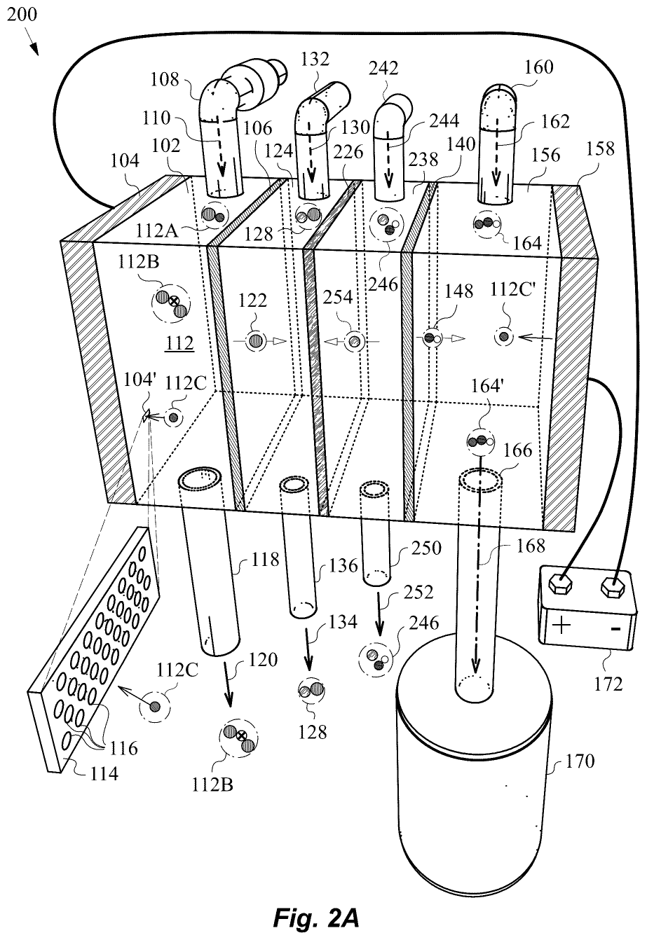

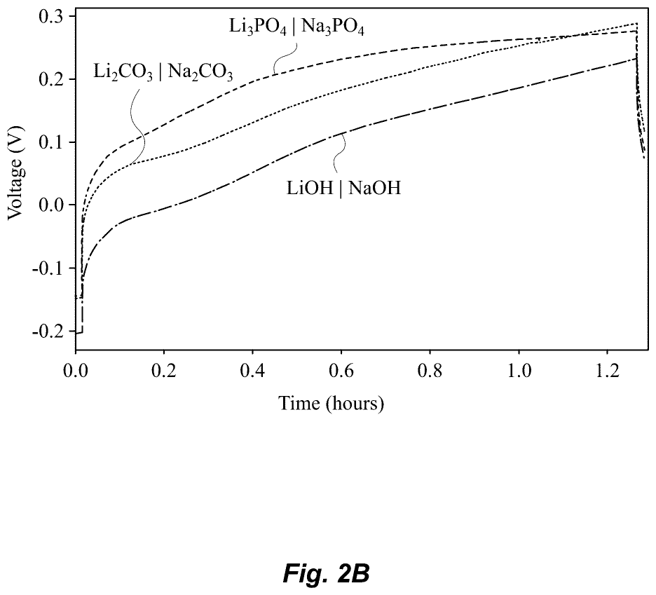

FIG. 2A is a three-dimensional schematic diagram of another embodiment of integrated electrochemical cell 200. Elements and parts of electrochemical cell 200 that are analogous to those of electrochemical cell 100 in the previous embodiment will retain reference numbers from that embodiment.

As in the previous embodiment, integrated electrochemical cell 200 has catholyte chamber 102 with Lithium intercalating electrode 104 on one side and first anion exchange membrane 106 on the other side. Brine supply pipe 108 is provided to deliver flow 110 of Lithium brine 112 into catholyte chamber 102. The component of interest in Lithium brine 112 is again Lithium Chloride (LiCl) 112A. Of the various other components in Lithium brine 112 only Magnesium Chloride (MgCl₂) 112B is shown explicitly. As in the prior embodiment, catholyte chamber 102 uses depleted brine outlet pipe 118 for removing depleted brine 120 largely devoid of Li⁺ cations 112C from further reactions.

Lithium intercalating electrode 104 is made of electrode material 114 whose enlarged portion 104′ visualizes intercalating electrode material 114 with sites 116 for intercalating Li⁺ cations 112C. Suitable electrode material 114 in the present embodiment also includes LiFePO₄, LiₓMe_{y}FePO₄, LiFeₓMe_{y}PO₄, LiFePO₄/C, LiₓMe_{y} FePO₄/C, LiFeₓMe_{y}PO₄/C, or a mixture thereof, in which, Me represents Mn, Co, Mo, Ti, Al, Ni, Nb, or a mixture thereof and the values of x and y are 0≤x≤1 and 0≤y≤1.

First anion exchange membrane 106 allows for passage of negatively charged ions, in particular Cl⁻ anions 122. Thus, Cl⁻ anions 122 exit catholyte chamber 102 through anion exchange membrane 106 which can be made of a suitable quaternary ammonium-based material.

Integrated electrochemical cell 200 has buffer chamber 124 sandwiched between first anion exchange membrane 106 of catholyte chamber 102 and an intermediate membrane which is a cation exchange membrane 226 in this embodiment. Buffer chamber 124 is a salt concentrating chamber that streams salt 128 of brine-predominant anion 122, which is again chloride salt 128 (NaCl) since brine-predominant anion is Cl⁻ in the embodiment shown. Chloride salt 128 is delivered in aqueous flow 130 though chloride salt supply pipe 132 and removed in aqueous form of flow 134 through chloride salt outlet pipe 136. It should be noted that other chloride salts can be used in buffer chamber 124, including salts such as magnesium, calcium, potassium, ammonium, pyridinium, hydrogen, aluminum, copper, phosphonium, ferrocenium and imidazolium chloride.

As before, chloride salt 128 is provided for removing Cl⁻ anions 122 arriving from catholyte chamber 102 through first anion exchange membrane 106. It is important to note that cation exchange membrane 226 does not permit further passage of Cl⁻ anions 122 out of buffer chamber 124 to any subsequent chambers of electrochemical cell 200 in this embodiment.

Further, integrated electrochemical cell 200 has a compatible anion chamber 238 sandwiched between cation exchange membrane 226 and a second anion exchange membrane 140. Compatible anion chamber 238 has a compatible compound supply pipe 242 for streaming a flow 244 of a compatible compound 246 for the formation of Lithium product. Compatible compound 246 for Lithium product formation can be a salt, such as a hydroxide salt or a base.

In the present embodiment, compatible compound 246 is a base, more specifically still, it is Sodium Hydroxide (NaOH) indicated in a highly enlarged view within a dashed and dotted outline. It should be noted that other hydroxide salts can be used, including magnesium, calcium, potassium, ammonium, pyridinium, hydrogen, aluminum, copper, phosphonium, ferrocenium, and imidazolium hydroxides. In addition, other basic anions can be used, including carbonate, bicarbonate and phosphate. Compatible compound 246 is considered compatible for Lithium product formation because it yields product anions, which in the present case are hydroxide anions (OH⁻) as indicated with exemplary OH⁻ anion 148 in magnified form within a dashed and dotted outline.

A compatible anion chamber outlet pipe 250 is provided for transporting a flow 252 of unused compatible compound 246 from compatible anion chamber 238. Note that in contrast to the prior embodiment that deployed an ion exchange chamber as compatible anion chamber, no chloride salt needs to be vacated through exchange outlet pipe 250 of compatible anion chamber 238. That is because cation exchange membrane 226 prevents Cl⁻ anions 122 from passing into compatible anion chamber 238. This enforced absence of Cl⁻ anions 122 from compatible anion chamber 238 and the consequent absence of any chloride salts that Cl⁻ anions 122 would form in compatible anion chamber 238 is advantageous, as further discussed below.

The cations from Lithium product compatible compound 246 are Sodium (Na⁺) cations 254, as indicated in the magnified and enlarged view within dashed and dotted line. Now, cation exchange membrane 226 permits the passage of cations (i.e., it is cation selective) and in particular selective for Na⁺ cations 254. Thus, Na⁺ cations 254 pass through cation exchange membrane 226 from compatible anion chamber 238 into buffer chamber 124, as shown in FIG. 2A. In alternative embodiments cell 200 can be designed to enable the transport of other cations as well, including magnesium, calcium, potassium, ammonium, pyridinium, hydrogen, aluminum, copper, phosphonium, ferrocenium, and imidazolium.

Anolyte chamber 156 is located adjacent to second anion exchange membrane 140 and thus next to compatible anion chamber 238. Anolyte chamber 156 has Lithium de-intercalating electrode 158 opposite from second anion exchange membrane 140. Lithium-bearing solution supply pipe 160 is provided to deliver flow 162 of Lithium-bearing solution 164 into anolyte chamber 156. In the present embodiment, Lithium-bearing solution 164 is LiOH that can be fresh or recycled. Note that in alternative embodiments Lithium-bearing solution 164 can include other Lithium species, such as Lithium carbonate, Lithium bicarbonate or Lithium phosphate, or, in fact, even no Lithium species at the time it is entering anolyte chamber 156. It may also contain other salt species that are not Lithium-bearing.

Lithium de-intercalating electrode 158 is also made of electrode material 114 that de-intercalates Li⁺ cations 112C′ under application of positive potential.

Anolyte chamber 156 is set up to receive product anions 148 from compatible anion chamber 238 through second anion exchange membrane 140. This produces the requisite operating conditions for producing Lithium product 164′, here aqueous LiOH designated with a prime to distinguish is from Lithium-bearing solution 164. Anolyte chamber outlet pipe 166 is provided for removing flow 168 of Lithium product 164′ to tank 170.

Integrated electrochemical cell 200 is also equipped with voltage source 172 to drive the intercalating of recovered Lithium 112C in catholyte chamber 102 and contemporaneous production of Lithium product 164′ in anolyte chamber 256. Voltage source 172 is reversible, meaning that its polarity can be reversed.

During operation flow 110 of Lithium brine 112 enters catholyte chamber 102 through brine supply pipe 108 while a negative overpotential is applied to Lithium intercalating electrode 104 by voltage source 172, thereby reducing electrode material 114. Thus, Li⁺ cations 112C are intercalated in sites 116 of electrode material 114 and Lithium brine 112 gets depleted of Li⁺ cations 112C. Outlet pipe 118 passes depleted brine 120 to ground or storage. Simultaneously with the passing of Lithium brine 112 through catholyte chamber 102, flow 162 of Lithium-bearing solution 164 is passed through anolyte chamber 156 from Lithium-bearing solution supply pipe 160. The positive overpotential applied to Lithium de-intercalating electrode 158 by voltage source 172 oxidizes electrode material 114 and causes Li⁺ cations 112C′ to de-intercalate and enter Lithium-bearing solution 164. Advantageously, the remainder of Lithium product 164′ is recycled into anolyte chamber 156 as Lithium-bearing solution 164. De-intercalated Li⁺ cations 112C′ enter LiOH solution 164 and pair with hydroxide anions 248 arriving from compatible anion chamber 138 via second anion exchange membrane 140 to produce Lithium product 164′ (LiOH).

As in the previous embodiment, buffer chamber 124 functions to facilitate transport of Cl⁻ anions 122 out of catholyte chamber 102 to avoid precipitation on first anion exchange membrane 106. In contrast to the prior embodiment, in electrochemical cell 200 the transport of Cl⁻ anions 122 out of buffer chamber 124 is prevented by cation exchange membrane 226 while Na⁺ cations 254 pass into buffer chamber 124 through cation exchange membrane 226. Thus, charge balance is maintained in buffer chamber 124 through movement of Na⁺ cations 254 from compatible anion chamber 238 into buffer chamber 124.

Given the simultaneous presence of Cl⁻ anions 122 and Na⁺ cations 254 in buffer chamber 124 more chloride salt 128 will form. Thus, the concentration of chloride salt 128 in buffer chamber 124 will increase. This means that chloride salt outlet pipe 136 will discharge flow 134 with a higher concentration of chloride salt 128 than is delivered to it by aqueous flow 130 through chloride salt supply pipe 132. Therefore, an adjustment to the concentration of chloride salt 128 prior to recycling can be made. Specifically, the concentration of chloride salt 128 can be reduced prior to recycling from chloride salt outlet pipe 136 back to chloride salt supply pipe 132. Performing desalination or water dilution is not explicitly shown in FIG. 2A but those skilled in the art will understand that there are many options for carrying out this step.

Meanwhile, the streaming of flow 244 containing compatible compound 246 for Lithium product formation, in this case NaOH, creates suitable conditions for producing product anions 148 that are compatible for Lithium product formation. Specifically, while NaOH serving as compatible compound 246 dissociates, Na⁺ cations 254 pass into buffer chamber 124 through cation exchange membrane 226 while product anions represented here by OH⁻ anions 148 pass through second anion exchange membrane 140 into anolyte chamber 156. More specifically, freed OH-anions 148 pass through second anion exchange membrane 140 into anolyte chamber 156 due to the potential difference applied between intercalating and de-intercalating electrodes 104, 158 by voltage source 172.

As compatible compound 246 dissociates to produce Na⁺ cations 254 and the desired product anions 148, its unused remainder passes out of compatible anion chamber 238 through compatible anion chamber outlet pipe 250 in the form of flow 252. At this point, the deficit in compatible compound 246 can be made up and recirculated into compatible anion chamber 238 via compatible compound supply pipe 242 in the form of flow 244. As noted above, since in this embodiment flow 252 does not contain any chloride salt 128 no extra purification steps are involved in recycling flow 244 of compatible compound 246.

The operation of integrated electrochemical cell 200 is simple, given that other than adjusting concentrations no other steps are required to recirculate both compatible compound 246 into compatible anion chamber 238 and also to recirculate chloride salt 128 into buffer chamber 124 through chloride salt supply pipe 132. This simplicity renders electrochemical cell 200 advantageous in practice. It is particularly advantageous that no accumulation of chloride ions in NaOH 246 supply channel removes the need for separation of chloride and hydroxide ions in compatible anion chamber 238, as would otherwise be required to continue generating LiOH instead of LiCl.

The solutions in compatible anion chamber 238 and anolyte chamber 156 shown in FIG. 2A are just one possible embodiment. In other embodiments, the NaOH solution could be replaced with a buffer solution such as sodium carbonate, sodium bicarbonate, sodium phosphate, sodium borate etc. The sodium cations can also be replaced with magnesium, calcium, potassium, ammonium, pyridinium, hydrogen, aluminum, copper, phosphonium, ferrocenium, and imidazolium cations. In any event, the goal of the modified architecture of integrated electrochemical cell 200 is to minimize the purification steps involved in recycling the electrolyte of the two middle channels, i.e., buffer chamber 124 and compatible anion chamber 238.

Note that in integrated electrochemical cell 100, intercalation/de-intercalation of Li⁺ in the cathode/anode respectively drives Cl⁻ across the anion exchange membranes (AEMs) to maintain charge neutrality. This will lead to chloride ion accumulation in the NaOH channel over time. Eventually separation of chloride and hydroxide ions in this chamber will be needed to continue generation of LiOH instead of LiCl. By using cation exchange membrane 226 as intermediate membrane chloride ions are limited to movement between buffer chamber 124 and catholyte chamber 102.

Meanwhile, in anolyte chamber 156, as Li⁺ cations 112C′ de-intercalate, OH⁻ anions 148 from compatible anion chamber 238 are drawn across second anion exchange membrane 140 into anolyte chamber 156. The net result is an increase in the concentration of Na⁺ and Cl⁻ in NaCl chamber or buffer chamber 124 and a decrease of Na⁺ and OH⁻ in the NaOH chamber or compatible anion chamber 238. These concentrations can be controlled by the addition of NaOH(, to the NaOH recycle loop and either precipitation of NaCl, dilution with water, or a reverse osmosis process to decrease the salt content in the NaCl chamber or buffer chamber 124. These processes will be simpler than selective separation of Cl⁻ and OH⁻ ions in solution.

As in the previous embodiment, the process runs until intercalating electrode 104 and/or de-intercalating electrode 158 reach certain lithiation states. Specifically, after a certain amount of time intercalating electrode 104 will approach a certain level of lithiation as Li⁺ cations 112C are trapped in sites 116 offered by electrode material 114. At full lithiation intercalating electrode 104 will thus stop being able to continue its capture of Li⁺ cations 112C. Similarly, after a certain amount of time, de-intercalating electrode 158 will be depleted of Li⁺ cations 112C′. It will thus stop being able to provide further Li⁺ cations 112C′ necessary for production of Lithium product 164′.

FIG. 2B shows plots of voltage over time in integrated electrochemical cell 200 of FIG. 2A. In this case, naturally-occurring brine catholyte and lithium product solution (containing Li₃PO₄, LiOH, Li₂CO₃) anolyte were continuously looped through cell 200. The changes in Lithium concentration for the catholyte in catholyte chamber 102 and for the anolyte in anolyte chamber 156 are shown in TABLE 2, below. In each case, a different compatible compound 246 was used, as indicated here and in the plots of FIG. 2B.

TABLE 2

| | | Initial | Final | Initial | Final |
|---|---|---|---|---|---|
| | Anion | Anolyte | Anolyte | Catholyte | Catholyte |
| | Exchange | Li conc. | Li conc. | Li conc. | Li conc. |
| Anolyte | Solution | (ppm) | (ppm) | (ppm) | (ppm) |
| Li₃PO₄ | Na₃PO₄ | 103 | 152 | 127 | 109 |
| LiOH | NaOH | 106 | 149 | 127 | 103 |
| Li₂CO₃ | Na₂CO₃ | 104 | 155 | 127 | 98 |

Just like integrated electrochemical cell 100, integrated electrochemical cell 200 also supports operation with different types of Lithium brine 112 delivered in flow 110. Specifically, integrated electrochemical cell 200 can work with brine-predominant anions other than Cl⁻ that need to be removed from catholyte chamber 102. For example, in some embodiments brine-predominant anions 122 will be carbonate anions (CO₃⁻²) or sulfate anions (SO₄⁻²). Correspondingly, salt 128 of the brine-predominant anion is then chosen to be a carbonate salt or a sulfate salt, respectively.

It will be apparent to a person skilled in the art that integrated electrochemical cells in accordance with the invention can be deployed in chemical systems in various configurations. The exact design will depend on the Lithium product as well as many factors known to those skilled.

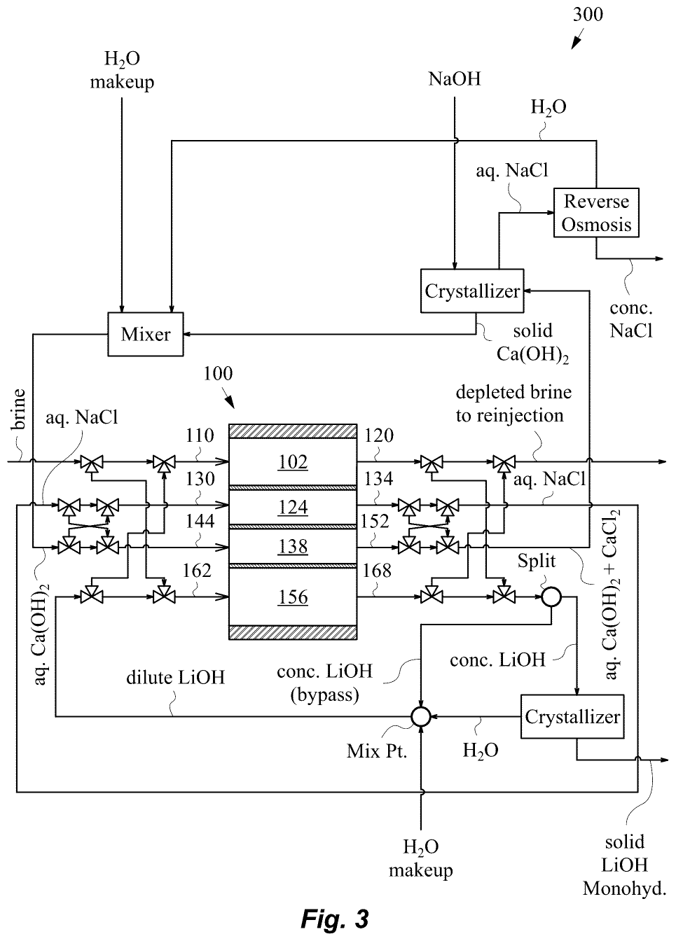

FIG. 3 is a schematic diagram of a chemical system 300 deploying integrated electrochemical cell 100 described above for obtaining LiOH as Lithium product 164′ and using Ca(OH)₂ as compatible compound 146 for Lithium product formation (see FIG. 1A). The streams entering and leaving chambers 102, 124, 138 and 156 are indicated expressly with the reference numerals used in FIG. 1A for clarity. It will be apparent that integrated electrochemical cell 200 or any other four-chamber cell according to the invention can be deployed in chemical system 300 with appropriate design. Given the disparate cation species used in the two central chambers of the electrochemical cell, system 300 is best suited for integrated electrochemical cell 100, and is not as well suited for electrochemical cell 200.

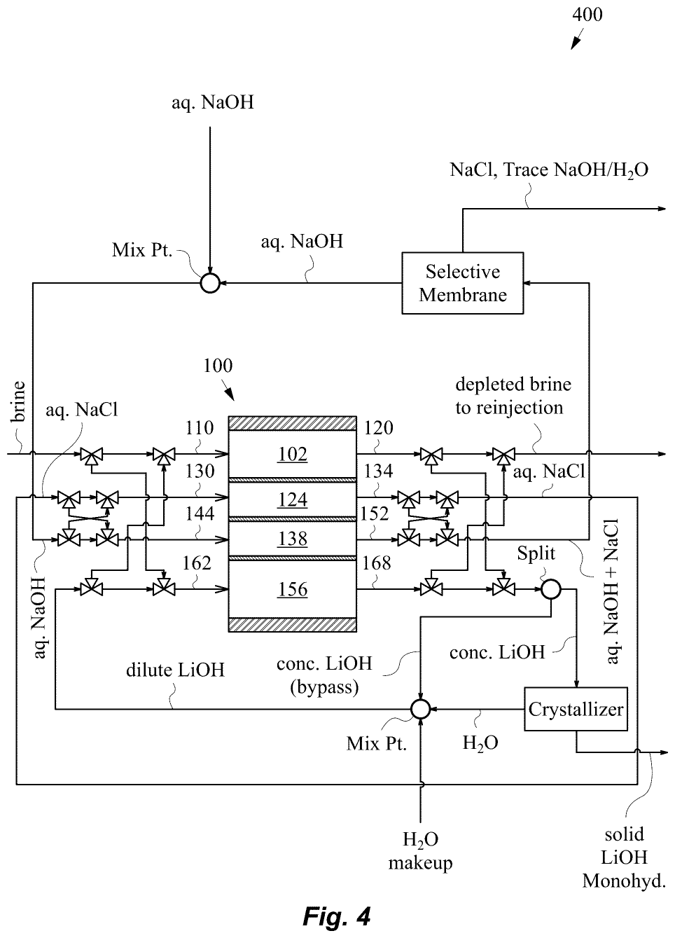

FIG. 4 is a schematic diagram of another chemical system 400 deploying integrated electrochemical cell 100 for obtaining LiOH as Lithium product 164′ but using NaOH as compatible compound 146 salt for Lithium product formation. The streams entering and leaving chambers 102, 124, 138 and 156 are indicated expressly with the reference numerals used in FIG. 1A for clarity.

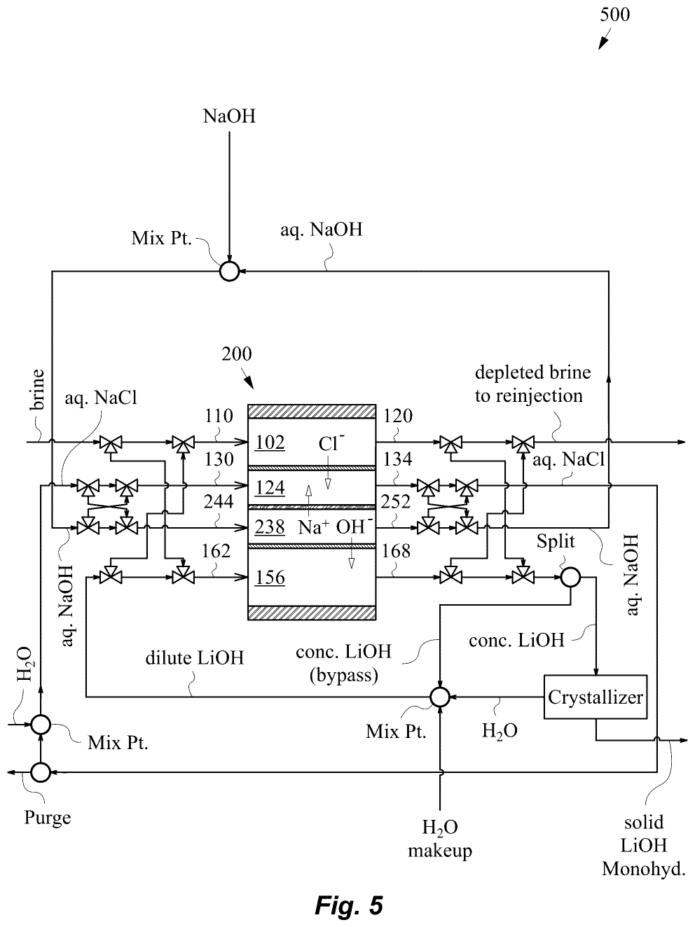

FIG. 5 is a schematic diagram of another chemical system 500 deploying integrated electrochemical cell 200 that uses cation exchange membrane as intermediate membrane in the center between chambers 124 and 238. Cell 200 is configured for obtaining LiOH as Lithium product 164′ and uses NaOH as compatible compound or compatible salt 246 (see also FIG. 2A) for Lithium product formation. The streams entering and leaving chambers 102, 124, 238 and 156 are indicated expressly with the reference numerals used in FIG. 2A for clarity.

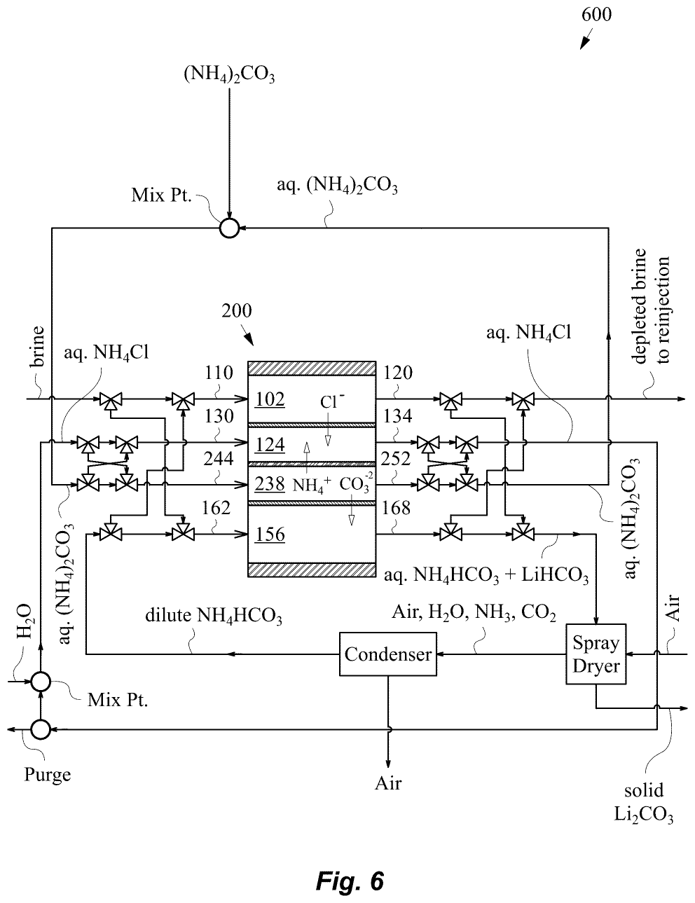

FIG. 6 is a schematic diagram of still another chemical system 600 deploying integrated electrochemical cell 200 that uses cation exchange membrane in the center between chambers 124 and 238. Cell 200 is configured for obtaining Li₂CO₃ as Lithium product 164′ and uses (NH₄)₂CO₃ as compatible salt 246 for Lithium product formation (see also FIG. 2A). The streams entering and leaving chambers 102, 124, 238 and 156 are indicated expressly with the reference numerals used in FIG. 2A for clarity. Chemical system 600 is potentially suited for operation without membranes separating each channel of electrochemical cell 200. In such a case, catholyte chamber 102 would mix with chamber 124, adding NH₄Cl to chamber 102, which would likely not affect reinjection of the brine. This would also allow some brine constituents to mix with NH₄Cl in chamber 124. Mixing between chambers 124 and 238 would not deleteriously affect system 600 if the streams of NH₄Cl and (NH₄)₂(CO₃)₂ are pure. If some brine constituents, such as MgCl₂, enter chamber 124, precipitated products such as Mg(CO₃)₂ may form on the interface between chamber 124 and 238, but the rate of this precipitation can be mitigated by allowing only short residence times of the flowing solutions in electrochemical cell 200 or by allowing only short electroswing cycles. Finally, the mixing of chambers 238 and 156 should not deleteriously affect the operation of system 600 given the chemical similarity of both chambers. The spray dryer downstream of electrochemical cell 200 should still produce pure Li₂CO₃ along with NH₃, CO₂ and H₂O vapors.

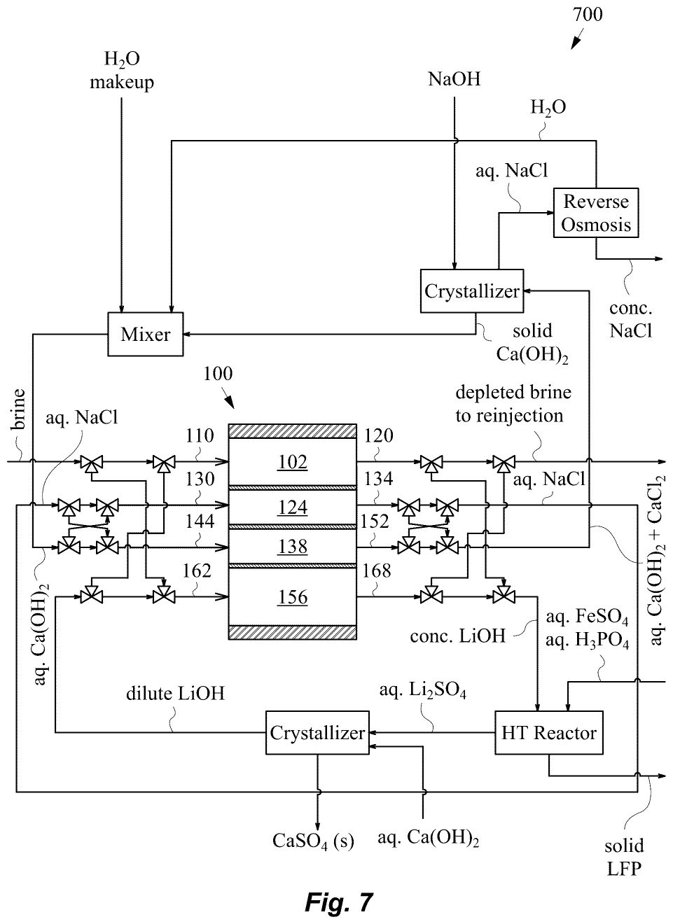

FIG. 7 is a schematic diagram of yet another chemical system 700 deploying integrated electrochemical cell 100 in a modified process for obtaining Lithium product 164′ that can be used as electrode material. Specifically, in the example shown Lithium product 164′ is LiFePO₄ (LFP) obtained via hydrothermal (HT) synthesis which allows for recycling of the unused Lithium product. The streams entering and leaving chambers 102, 124, 138 and 156 are again indicated expressly with the reference numerals used in FIG. 1A for clarity. As with the above systems, chemical system 700 can alternatively use integrated electrochemical cell 200 or indeed any other four-chamber cell according to the invention. In addition, other lithium-ion battery materials besides LiFePO₄ (LFP), such as LiNiₓMn_{y}Co_{1-x-y}O₂, LiₓMe_{y}FePO₄, LiFeₓMe_{y}PO₄, LiFePO₄/C, LiₓMe_{y}FePO₄/C, LiFeₓMe_{y}PO₄/C, in which, Me represents Mn, Co, Mo, Ti, Al, Ni, Nb, or a mixture thereof and the values of x and y are 0<x<1 and 0<y<1, may be synthesized with such a process.

A person skilled in the art will appreciate that still other chemical systems can deploy integrated electrochemical cells according to the invention. Furthermore, integrated electrochemical cells of the invention are highly versatile and can be combined with additional processing equipment. A particularly advantageous feature of these cells is the ability to stack many four-chamber cell units into a single cell stack.

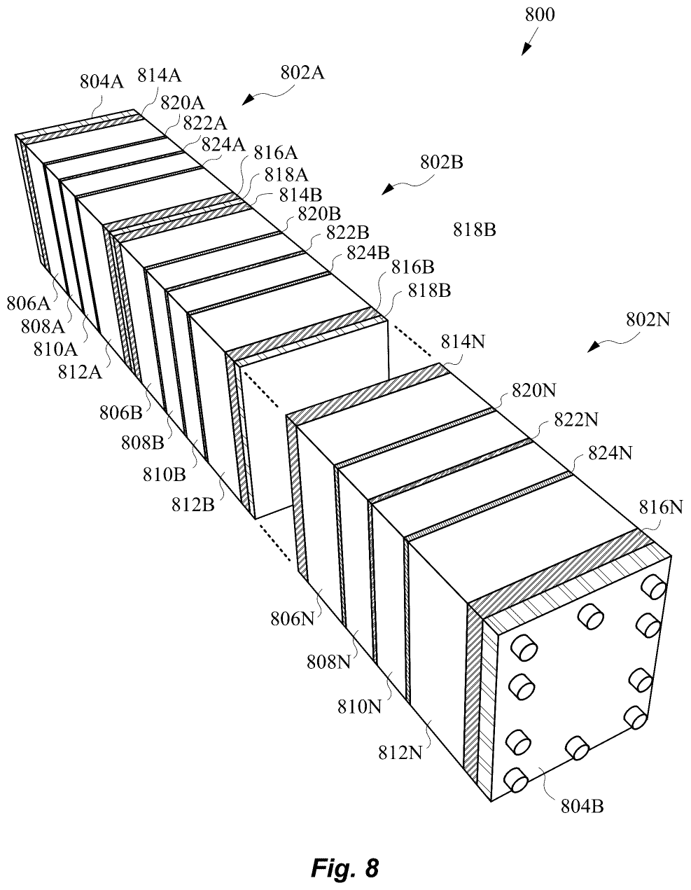

FIG. 8 is a schematic diagram of an integrated electrochemical stack 800 including a number of integrated electrochemical cells 802A, 802B, . . . , 802N. Stack 800 sandwiches integrated electrochemical cells 802A, 802B, . . . , 802N between a first bipolar plate 804A and a second bipolar plate 804B. Each one of electrochemical cells 802A, 802B, . . . , 802N has four corresponding chambers, namely catholyte chambers 806A, 806B, . . . , 806N, buffer chambers 808A, 808B, . . . , 808N, compatible anion chambers 810A, 810B, . . . , 810N and anolyte chambers 812A, 812B, . . . , 812N. The chambers are in turn sandwiched between Lithium intercalating electrodes 814A, 814B, . . . , 814N and Lithium de-intercalating electrodes 816A, 816B, . . . , 816N. Bipolar plates 818A, 818B, . . . , 818N-1 (last not shown) separate cells 802A, 802B, . . . , 802N.

The chambers of electrochemical cells 802A, 802B, . . . , 802N have interposed between them first anion exchange membranes 820A, 820B, . . . , 820N, intermediate membranes 822A, 822B, . . . , 822N, and second anion exchange membranes 824A, 824B, . . . , 824N, as shown. Intermediate membranes 822A, 822B, . . . , 822N can be anion selective (e.g., to permit the passage of Cl⁻ anions) or cation selective (e.g., to permit the passage of Na⁺ cations). In still other embodiments, intermediate membranes 822A, 822B, . . . , 822N can be of a type that are not ion selective and support the passage of entire salt species.

The advantage of stack 800 is that it minimizes the amount of piping, stream inlet/outlet points and endplates required to process brine and derive the desired Lithium product according to the invention. The geometry of stack 800 also decreases the areal footprint of the lithium processing unit as compared to many individual cell units, which would each require separate endplates, piping and fixtures, thus leading to significant capital expense savings.

It will be evident to a person skilled in the art that the present invention admits of still other embodiments and variants. Therefore, its scope should be judged by the claims and their legal equivalents.

1. An integrated electrochemical cell for processing a Lithium brine to obtain a recovered Lithium and to produce a Lithium product, said integrated electrochemical cell comprising:
a) a catholyte chamber for admitting said Lithium brine, said catholyte chamber having a Lithium intercalating electrode for intercalating said recovered Lithium from said Lithium brine and a first anion exchange membrane;
b) a buffer chamber sandwiched between said first anion exchange membrane and an intermediate membrane, said buffer chamber streaming a salt of a brine-predominant anion for removing said brine-predominant anion from said catholyte chamber to prevent precipitate formation on said first anion exchange membrane;
c) a compatible anion chamber sandwiched between said intermediate membrane and a second anion exchange membrane, said compatible anion chamber streaming a compatible compound for obtaining product anions for said Lithium product and passing said product anions from said compatible anion chamber through said second anion exchange membrane;
d) an anolyte chamber adjacent to said second anion exchange membrane for receiving said product anions and having a Lithium de-intercalating electrode, said anolyte chamber streaming a Lithium-bearing solution and said Lithium de-intercalating electrode releasing Lithium into said anolyte chamber to pair with said product anions to form said Lithium product; and
e) a voltage source for applying a potential difference between said Lithium intercalating electrode and said Lithium de-intercalating electrode to drive said intercalating of said recovered Lithium and production of said Lithium product.

2. The integrated electrochemical cell of claim 1, wherein said intermediate membrane is selected from the group consisting of an anion exchange membrane, a cation exchange membrane and a membrane that is not ion selective and permits traversal by entire salt species.

3. The integrated electrochemical cell of claim 1, wherein said Lithium product is a Lithium salt recovery solution.

4. The integrated electrochemical cell of claim 3, wherein said Lithium salt recovery solution is aqueous LiOH and said compatible salt is a hydroxide salt.

5. The integrated electrochemical cell of claim 3, wherein said Lithium salt recovery solution is aqueous Li₂CO₃ and said compatible salt is a carbonate salt.

6. The integrated electrochemical cell of claim 3, wherein said Lithium salt recovery solution is aqueous LiHCO₃ and said compatible salt is a bicarbonate salt or a carbonate salt.

7. The integrated electrochemical cell of claim 3, wherein said Lithium salt recovery solution is aqueous Li₃PO₄ and said compatible salt is a phosphate salt.

8. The integrated electrochemical cell of claim 3, further comprising a processing unit connected to said anolyte chamber for admitting said Lithium salt recovery solution and for processing said Lithium salt recovery solution to obtain a solid Lithium product.

9. The integrated electrochemical cell of claim 1, wherein said voltage source is a reversible voltage source for applying a reversed potential difference between said Lithium intercalating electrode and said Lithium de-intercalating electrode, thereby reversing the polarity of said integrated electrochemical cell.

10. The integrated electrochemical cell of claim 9, wherein said reversed potential difference is applied by said reversible voltage source when said Lithium intercalating electrode achieves a predetermined lithiation.

11. The integrated electrochemical cell of claim 9, wherein said reversed potential difference is applied by said reversible voltage source when said Lithium de-intercalating electrode achieves a predetermined de-lithiation.

12. The integrated electrochemical cell of claim 1, wherein said Lithium intercalating electrode and said Lithium de-intercalating electrode comprise electrode materials selected from among LiFePO₄, LiₓMe_{y}FePO₄, LiFeₓMe_{y}PO₄, LiFePO₄/C, LiₓMe_{y} FePO₄/C, LiFeₓMe_{y}PO₄/C, or a mixture thereof, in which, Me represents Mn, Co, Mo, Ti, Al, Ni, Nb, or a mixture thereof and the values of x and y are 0<x<1 and 0<y<1.

13. The integrated electrochemical cell of claim 1, wherein at least one of said Lithium intercalating electrode and said Lithium de-intercalating electrode has an increased volumetric active material loading capacity.

14. The integrated electrochemical cell of claim 13, wherein said increased volumetric active material loading capacity is provided by electrode folding.

15. The integrated electrochemical cell of claim 13, wherein said increased volumetric active material loading capacity is provided by a coating of an electrode material onto a conductive foam comprising at least one of said Lithium intercalating electrode and said Lithium de-intercalating electrode.

16. The integrated electrochemical cell of claim 1, wherein said catholyte chamber, said buffer chamber, said compatible anion chamber and said anolyte chamber are not separated by said first anion exchange membrane, said intermediate membrane and said second anion exchange membrane, and whereby streams of said Lithium brine, said chloride salt, said compatible compound and said Lithium-bearing solution mix.

17. The integrated electrochemical cell of claim 16, further comprising a means for purification and recycling of said streams of said chloride salt, said compatible compound and said Lithium-bearing solution.

18. The integrated electrochemical cell of claim 17, wherein said means for purification and recycling are selected from among membrane-based apparatus and precipitation-based apparatus.

19. A method for processing a Lithium brine to obtain a recovered Lithium and to produce a Lithium product by using an integrated electrochemical cell having a catholyte chamber, a buffer chamber, a compatible anion chamber and an anolyte chamber, the method comprising:
a) admitting said Lithium brine into said catholyte chamber having a Lithium intercalating electrode for intercalating said recovered Lithium from said Lithium brine and a first anion exchange membrane;
b) sandwiching said buffer chamber between said first anion exchange membrane and an intermediate membrane, said buffer chamber streaming a salt of a brine-predominant anion for removing said brine-predominant anion from said catholyte chamber to prevent precipitate formation on said first anion exchange membrane;
c) sandwiching said compatible anion chamber between said intermediate membrane and a second anion exchange membrane, said compatible anion chamber streaming a compatible compound for obtaining product anions for said Lithium product and passing said product anions from said compatible anion chamber through said second anion exchange membrane;
d) placing an anolyte chamber adjacent to said second anion exchange membrane for receiving said product anions and having a Lithium de-intercalating electrode, said anolyte chamber streaming a Lithium-bearing solution and said Lithium de-intercalating electrode releasing Lithium into said anolyte chamber to pair with said product anions to form said Lithium product; and
e) applying a potential difference between said Lithium intercalating electrode and said Lithium de-intercalating electrode to drive said intercalating of said recovered Lithium and production of said Lithium product.

20. The method of claim 19, wherein said intermediate membrane is selected from the group consisting of an anion exchange membrane, a cation exchange membrane and a membrane that is not ion selective and permits traversal by entire salt species.

21. The method of claim 19, wherein said voltage source is a reversible voltage source for applying a reversed potential difference between said Lithium intercalating electrode and said Lithium de-intercalating electrode, thereby reversing the polarity of said integrated electrochemical cell.

22. The method of claim 19, wherein said Lithium intercalating electrode and said Lithium de-intercalating electrode comprise electrode materials selected from among LiFePO₄, LiₓMe_{y}FePO₄, LiFeₓMe_{y}PO₄, LiFePO₄/C, LiₓMe_{y} FePO₄/C, LiFeₓMe_{y}PO₄/C, or a mixture thereof, in which, Me represents Mn, Co, Mo, Ti, Al, Ni, Nb, or a mixture thereof and the values of x and y are 0<x<1 and 0<y<1.

23. The method of claim 19, wherein said catholyte chamber, said buffer chamber, said compatible anion chamber and said anolyte chamber are not separated by said first anion exchange membrane, said intermediate membrane and said second anion exchange membrane, and whereby streams of said Lithium brine, said chloride salt, said compatible compound and said Lithium-bearing solution mix.

24. A Lithium product obtained by processing a Lithium brine to obtain a recovered Lithium and said Lithium product using an integrated electrochemical cell having a catholyte chamber, a buffer chamber, a compatible anion chamber and an anolyte chamber, said Lithium product being obtained by:
a) admitting said Lithium brine into said catholyte chamber having a Lithium intercalating electrode for intercalating said recovered Lithium from said Lithium brine and a first anion exchange membrane;
b) sandwiching said buffer chamber between said first anion exchange membrane and an intermediate membrane, said buffer chamber streaming a salt of a brine-predominant anion for removing said brine-predominant anion from said catholyte chamber to prevent precipitate formation on said first anion exchange membrane;
c) sandwiching said compatible anion chamber between said intermediate membrane and a second anion exchange membrane, said compatible anion chamber streaming a compatible compound for obtaining product anions for said Lithium product and passing said product anions from said compatible anion chamber through said second anion exchange membrane;
d) placing an anolyte chamber adjacent to said second anion exchange membrane for receiving said product anions and having a Lithium de-intercalating electrode, said anolyte chamber streaming a Lithium-bearing solution and said Lithium de-intercalating electrode releasing Lithium into said anolyte chamber to pair with said product anions to form said Lithium product; and
e) applying a potential difference between said Lithium intercalating electrode and said Lithium de-intercalating electrode to drive said intercalating of said recovered Lithium and production of said Lithium product.
